(19) United States
(12) Patent Application Publication
(10) Pub. No.: US 2005/0129314 A1
(43) Pub. Date: Jun. 16, 2005

(54) System and method for constructing large-scaled drawings of similar objects

(76) Inventor: Ming-Jang Chen, Hsinchu (TW)

Correspondence Address: TROXELL LAW OFFICE PLLC, SUITE 1404, 5205 LEESBURG PIKE, FALLS CHURCH, VA, 22041, US

(21) Appl. No.: 10/815,819

(22) Filed: Apr. 2, 2004

(30) Foreign Application Priority Data
Dec. 10, 2003 (TW) 092134925

(51) Int. Cl. G06K 9/62; G06K 9/00; G06K 9/66; G06T 11/20; G06T 15/00; G06T 17/00; G09G 5/00

(52) U.S. Cl. 382/209; 382/181; 382/190; 382/224; 345/441; 345/419; 345/428; 345/619

(57) ABSTRACT

This invention provides a system and method for constructing pictures, particularly to one capable of drawing large-scaled drawings of similar objects through the analog rule and iterative duplication, such that an end-user is able to create and design various fractals or other complicated pictures containing large-scaled drawings of similar objects based on simple designs of patterns and targeted line segments as well adjustment of baselines. This invention may be adopted in the fields of artistic designs, drafting and instructions due to the simple operations as involved.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to a system and method for constructing pictures, particularly to one capable of drawing large-scaled drawings of similar objects through the analog rule and iterative duplication.

### BACKGROUND

In the past, complicated drawings are mostly drawn one by one by means of hand or various drawing software, such as AutoCAD, Flash, PhotoShop, Illustrator, and CorelDraw. Such drawing software is each featured with specialized design features to be adapted to specialized applications. However, an extended period of time may be required to compute the precise position, length and azimuth of each line segment while applying such drawing software in drawing some particular and complicated geometric figures, such as fractal arrangements containing large-scaled drawings of similar objects. On the other hand, such figures may also be realized by adopting MatLab, Mathematica or GSP (geometer's sketchpad) to record and establish mathematical models or to write programs. However, the entry barrier for application of such software for those who are not specialized in mathematics or information technology would be extremely high.

Fractal geometry is presently implemented in representing and analyzing complicated patterns found in the great nature. For example, the basic compositions of flowers, grass, trees, mountains, rocks, surfs, rivers, shorelines, stars, clouds, lightening, snowflakes, growth of bacteria and crystals and configurations of blood vessels, can all be represented by fractals. Certain relevancy exists among fractals, chaos and dynamic system. In addition, fractals play a significant role in the applications of complicated system, graphics, genetic and information technology.

Common fractals consist of three characteristics, including (1) self-similarity, (2) no-where differentiabiltiy, and (3) non-integral dimensions [J. Hutchinson, Fractals and self-similarity, Indiana Univ. J. Math. 30, 713-747 (1981)]. The so-called self-similarity refers to the similarity between the patterns of local and overall compositions in the variations of length, width, azimuth and transformation. The dimensions of lines, faces and bodies in common planar geometry are integers while those in fractals are non-integers.

Mandelbrot is generally acknowledged to be the father of fractal geometry. Though numerous classical mathematicians preceding Mandelbrot, including George Cantor (1872), Giuseppe Peano (1890), David Hilbert (1891) and Helge von Koch (1904) have proposed examples pertaining to fractals, the outcomes of their researches were only used to represent the ingenuity of geometric figures and the fundamental properties of mathematics of the time. Mandelbrot, on the other hand, developed fractal geometry into a new field of geometry, made relevant comparision between the fractals drawings developed by the predecessors with the distinguishing characteristics of the compositions found in the great nature, and further developed a descriptive language to represent fractals by formal and Backus-Naur form languages. In more modern times, Chomsky adopts the formal and Backus-Naur form languages in coordination with the characteristics of ALGOL-60 to represent fractals [Smith, A. R., Plants, Fractals, and Formal Languages, Computer Graphics, 18, 3, 1984, Pages 1-10].

In 1968, Aristid Lindemmayer, a biologist, first announced an L-system for generating fractals [Prusinkiewicz. P, Graphical Applications of L-Systems, Proc. of Graphics Interface 1986—Vision Interface, 1986, Pages 247-253.], as known as Parallel Rewriting Systems). This system was designed to develop symbolic language for representing the forms and growth process of plants, and thereby being considered one pertaining to the mathematical theory of plant growth.

MRCM: A particular feedback system consists of a copy machine with multiple lenses, each lens with different reduction factor and the displacement of the reduction images. Such copy machine is a multiple reduction copy machine (MRCM). This is also one of approaches for designing fractals.

Iterated Function System (IFS) is another approach for designing fractals [M. F. Barnsley and S. Demko, Iterated function systems and the global construction of fractals, Proc. Roy. Soc. London A399, 243-275 (1985)], which starts with simple drawings that are subsequently subject to a series of transformations (or geometrical transformations), where the initialization of each of which transformations is determined by probability. This application is widely implemented for its compatibility to non-fractal drawings.

Prior researches relevant to fractals include characteristics, generation, tolerances, compressions and artistic of fractals. The process of generating fractals may be treated as iteration of self-similarity. An extensive line of rules must be first defined for the designing of fractals. According to the rules, a new object is subject to translation, scaling, rotation, inclination, and placement at a specific position. The process of growing fractals requires a large quantity of complicated computations. Different programs, language or specialized software must be implemented in the designing of different fractals. The difficulty involved in the applications by the general public to design custom fractals results in reduced popularization.

In view of the shortcomings involved in the applications of prior art and theories in drawing complicated pictures, a system and method for constructing pictures is disclosed to provide a simple technology for construction pictures using iterative duplication, thereby transforming simple and plan basic drawings into complicated pictures containing large-scaled drawings of similar objects.

### SUMMARY OF INVENTION

It is a primary objective of this invention to provide a system and method for constructing large-scaled drawings of similar objects to enhance the capability of drawings complicated pictures, where fractals or other complicated pictures containing large-scaled drawings of similar objects with regularity may be designed by end-users with the provision of basic patterns and line segments, thereby achieving the objective of popularization.

It is another objective of this invention to provide a system and method for constructing pictures, for generating large-scaled drawings of similar objects, where a pattern is directly used as the bases for generating pictures, by first identifying the relative relationship between the pattern and baseline, and then duplicating duplications along the targeted line segment with identical relationship by means of iterative duplication(s), in which similarity and analog relationship exist between the duplications and the patterns, to obtain an picture containing large-scaled drawings of similar objects after being subject to multiple duplications.

It is a further objective of this invention to provide a method for constructing pictures, for generating large-scaled drawings of similar objects, comprising the steps of: (a) inputting a pattern, a baseline, and a targeted line segment at a first, a second and a third positions, respectively, by an end-user, the pattern, baseline and targeted line segment having a first, a second and a third dimensions and a first, a second and a third azimuths, respectively; (b) analyzing the relative relationship between the pattern and the baseline in accordance with the positions, dimensions and azimuths of the pattern and baseline; (c) generating a first duplication at a fourth position through iterative duplication, by scaling the pattern with a first ratio and then translating the pattern in accordance with the second position, dimension and azimuth of the line segment using the relative relationship between the pattern and the baseline as a reference, such that the first duplication and the targeted line segment conform with the relative relationship between the pattern and the baseline; and (d) displaying the first duplication at the fourth position as a first picture for examination of the end-user.

Accordingly, the pattern includes at least a first line segment or a random object. The baseline is a line segment. The targeted line segment may include plural line segments with different azimuths and dimensions. The first duplication includes at least a second line segment due to conformity with the relative relationship with respect to positions, dimensions and azimuths.

Accordingly, the method further comprises the steps of: (e) identifying a fifth position at where the second line segment is located, and detecting a fifth dimension and azimuth of the second line segment; (f) treating the second line segment as a new targeted line segment, and generating a second duplication of the pattern at a sixth position by scaling the pattern with a second ratio and translating the pattern in accordance with the fifth position, dimension, azimuth of the second line segment using the relative relationship between the pattern and the baseline as a reference, such that the second duplication and the second line segment conform with the relative relationship between the pattern and the baseline; and (g) displaying the second duplication at the sixth position as a second picture for examination of the end-user.

Accordingly, the second line segment is an iterated line serving as a targeted line segment to be used in the subsequent iterative duplication(s), where the position, dimension and azimuth of the second line segment are detected by a detecting unit, and the patterns used by the first and second duplications may be freely changed.

Accordingly, the method further comprises the steps of: (h) treating the plural line segments generated by repeating steps (e) and (f) as plural iterated lines and generating different pictures using the plural iterated lines, where in step (h), the end-user may configure the number of the iterated lines that are not subject to subsequent iterative duplication(s), or the frequency of the number of the iterated lines that are subject to subsequent iterative duplication(s) or alternative iterative duplications, to generate a picture having timing differences, or the end-user may configure the attributes of the duplications or pictures to facilitate advanced processing.

Accordingly, the configuration of the attributes includes subjecting the duplications or pictures to transformation, such as mirror reflection and rotation, and hue tuning to generate transformed drawings of similar pictures. The transformation is achieved by geometrical transformation and computation of linear algebra to generate the transformed drawings of similar pictures.

Accordingly, the first ratio is a quotient between the pattern and the baseline, which equals to a quotient between the first duplication and the targeted line segment. The relative relationship between the fourth and third positions equals to the relative relationship between the first and second positions. The second ratio is a quotient between the pattern and the baseline, which equals a quotient between the second duplication and second line segment. The local drawings in the first and second duplications are the same as the pattern.

It is a further objective of this invention to provide a system for constructing large-scaled drawings of similar objects, comprising: a storage module; an interface device serving as an input device to be used an end-user to input a pattern, a baseline and a targeted line segment; a detecting unit, for detecting and identifying positioning information, including relative positions, dimensions, azimuths and centers of the pattern, baseline and targeted line segment upon inputting the pattern, baseline and targeted line segment, and storing the positioning information in the storage module; an analyzing unit, for obtaining a relative relationship existing between the pattern and the baseline to be stored in the storage module upon accessing the positioning information stored in the storage module; and a calculating unit, for calculating positioning information of a first duplication based on the positioning information of the targeted line segment upon accessing the relative relationship stored in the storage module and the positioning information of the targeted line segment, thereby subjecting a relative relationship between the first duplication and the targeted line segment to conform with the relative relationship between the pattern and the baseline, and for displaying the first duplication on the interface device.

Accordingly, the pattern includes a first line segment. The first duplication includes a second line segment due to conformity with the pattern. The calculating unit treats the second line segment as a new targeted line segment, to generate a second duplication upon accessing the relative position, dimension, azimuth and center of the second line segment.

Accordingly, the calculating unit allows configuration of attributes of the line segment of the second duplication or the object in response to configuration made by the end-user to facilitate advanced processing of the second duplication, wherein the configuration of the attributes includes geometrical transformation, such as mirror reflection and rotation, and hue tuning.

Accordingly, an analog relationship is formed between the first and second duplications, wherein the analog relationship is represented by a quotient between the pattern and the baseline, which equals to a quotient between the first duplication and the targeted line segment, which equals to a quotient between the second duplication and second line segment.

Accordingly, the relative relationship includes a distance between centers of the pattern and the baseline, and an included angle between a line connecting the two centers and the baseline. The targeted line segment includes at least one line segment and the baseline is a line segment.

It is another objective of this invention to provide a method for constructing pictures, for generating large-scaled drawings of similar objects, comprising the steps of: providing a pattern, a baseline and a targeted line segment; analyzing a relative relationship between the pattern and the baseline; and generating a first duplication along the targeted line segment having a relative relationship identical to the relative relationship and displaying the first duplication as a first picture.

Accordingly, the method further comprises the steps of: treating each line segment of the first duplication as a new targeted line segment; and generating a second duplication along each of the line segments of the first duplication having a relative relationship identical to the relative relationship and displaying the second duplications as a second picture.

Accordingly, the method further comprises the steps of: subjecting the line segments in the second duplications and the object to transformation, such as mirror reflection and rotation, and hue tuning to generate transformed drawings of similar pictures, wherein the new targeted line segment is an iterated line, and the number of the iterated lines that are not subject to subsequent iterative duplication(s), and the frequency of the number of the iterated lines that are subject to subsequent iterative duplication(s) or alternative iterative duplications may be configured to generate a picture having timing differences.

It is a further objective of this invention to provide a system for constructing large-scaled drawings of similar objects, comprising: an interface device and a system control module, the interface device serving as an input device to be used by an end-user to input a pattern, a baseline and a targeted line segment to generate a duplication, characterized in that: the system control module generates a first duplication analogous to the pattern and displayed on the interface device upon identifying positioning information of and analyzing a relative relationship between the pattern and the baseline, such that a relative relationship between the first duplication and the targeted line segment conforms with the relative relationship between the pattern and the baseline.

Accordingly, the system control module is able to treat the first duplication as a new targeted line segment to generate a second duplication analogous to the pattern and displayed on the interface device, such that a relative relationship between the second and first duplications conforms with the relative relationship between the pattern and the baseline. The line segments in the pattern may further be subject to transformation, such as mirror reflection and rotation, and hue tuning to generate transformed drawings of similar pictures.

### BRIEF DESCRIPTION OF THE DRAWINGS

These and other modifications and advantages will become even more apparent from the following detained description of a preferred embodiment of the invention and from the drawings in which:

The following explanations are directed to the description of preferred embodiments for the system for constructing pictures according to this invention. Since this invention is not limited to the specific details for the method and system described in connection with the preferred embodiments, changes and implementations to certain features of the preferred embodiments without altering the overall basic features of the invention are contemplated within the scope of the appended claims.

FIG. 1 is a schematic view illustrating a simple arrangement of the system for constructing pictures according to this invention.

FIG. 2 is a schematic view illustrating the flowchart adopting the method for constructing pictures according to this invention.

FIGS. 3(A) and 3(B) illustrate the operative principles of the system for constructing pictures according to this invention.

FIGS. 4(A) to 4(E) illustrate a resulting picture generated by a first embodiment of the system for constructing pictures according to this invention, after being subject to multiple iterative duplications based on a pattern, baseline and a targeted line segment.

FIGS. 5(A) to 5(C) illustrate different resulting pictures generated by a second embodiment of the system for constructing pictures according to this invention, using a pattern and a line segment identical to those in FIG. 4 and baselines of different azimuths.

FIGS. 6(A) to 6(D) illustrate the resulting pictures generated by a third embodiment of the system for constructing pictures according to this invention, where different patterns are used for the iterative duplications.

FIGS. 7(A) to 7(D) illustrate the resulting pictures of a Pythagorean tree generated by a fourth embodiment of the system for constructing pictures according to this invention, using a square object and two line segments as the pattern.

FIGS. 8(A) to 8(D) illustrate the resulting pictures generated by a fifth embodiment of the system for constructing pictures according to this invention, after being subject to multiple iterative duplications of a targeted line segment containing line segments with different azimuths.

FIGS. 9(A) to 9(D) illustrate the resulting pictures generated by a sixth embodiment of the system for constructing pictures according to this invention, after being subject to multiple iterative duplications based on a baseline and a targeted line segment identical to those in FIG. 8 and different patterns.

FIGS. 10(A) to 10(D) illustrate the resulting pictures generated by a seventh embodiment of the system for constructing pictures according to this invention, after being subject to multiple iterative duplications based on a targeted line segment containing plural line segments with different azimuths.

FIGS. 11(A) to 11(D) illustrate the comparative resulting pictures generated by an eighth embodiment of the system for constructing pictures according to this invention, where duplications with and without timing differences are used during the iterative duplication(s).

### DETAILED DESCRIPTION OF THE INVENTION (PREFERRED EMBODIMENTS)

System Arrangement

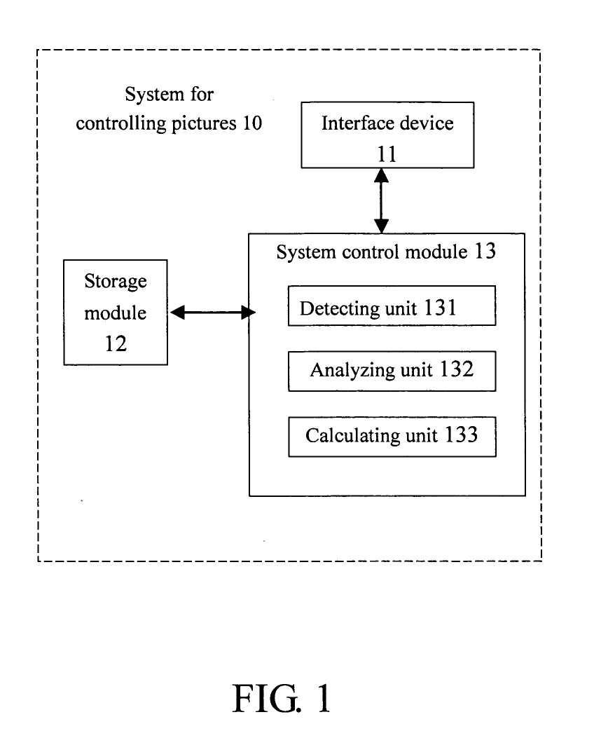

FIG. 1 is a schematic view illustrating a simple arrangement of the system for constructing pictures according to this invention. The system for constructing pictures 10 of this invention is implemented in drawing complicated pictures containing large-scaled drawings of similar objects. The system for constructing pictures 10 of this invention comprises: an interface device 11, a storage module 12, a system control module 13, wherein the interface device 11 serves as an input device to be used by an end-user to input any picture or line segment information, the system control module 13 generates a first resulting picture, upon positioning, detecting, analyzing and calculating processes, to be displayed on the interface device for examination of the end-user, and the storage module 12 serves to store or access outcomes processed by the system control module 13 while the system control module 13 performs the above processes. Further details are described as follows.

The embodiment of the system for constructing pictures 10 of this invention requires an end-user to input a pattern, a baseline and a targeted line segment through the interface device 11, which are then transferred to the system control module 12 for processing. The system control module includes a detecting unit 131, an analyzing unit 132 and a calculating unit 133. Because the pattern, baseline and targeted line segment are segment information inputted by manual or mouse selections, the detecting unit 131 would need to identify the relative coordinates and positioning information, including relative positions, dimensions, azimuths and centers of the pattern, baseline and targeted line segment, to detect whether the pattern, baseline and targeted line segment contain single or multiple line segments, and to store the positioning information in the storage module, regardless of the pattern, baseline and targeted line segment being line segments, curves or patterns.

The analyzing unit 132 would then obtain a relative relationship existing between the pattern and the baseline to be stored in the storage module upon accessing the positioning information, including the relative positions, dimensions, azimuths and centers of the pattern, baseline and targeted line segment, stored in the storage module, and store the relative relationship in the storage module 12.

The calculating unit 133 would generate a first duplication along the targeted line segment upon accessing the relative relationship between the pattern and the baseline as obtained by the analyzing unit 132 and the positioning information of the targeted line segment, including the relative position, dimension, azimuth and center, as identified by the detecting module 131, having a relative relationship between the first duplication and the targeted line segment being in conformity with the relative relationship between the pattern and the baseline, that may be represented by the following analog rule:

$$\frac{pattern}{baseline} = \frac{first duplication}{targeted segement}$$

As such, the calculating unit 133 would be able to obtain the relative position, dimension, azimuth and center of the first duplication by means of simple geometrical computations, such that the relative relationship between the first duplication and the targeted line segment is in conformity with the relative relationship between the pattern and the baseline. The first duplication is then displayed on the interface device 11 for examination of the end-user. The targeted line segment is not displayed on the interface device 11 to avoid causing confusion to the overall display.

The relative relationship includes a distance between centers of the pattern and the baseline, and an included angle between a line connecting the two centers and the baseline. Because the computation of the analog rule is a result of geometry, the baseline should be a line segment and the targeted line segment should include at least one line segment in order to effectively generate a picture similar to the pattern.

The pattern may be an object in the form of a line segment, a curve or a pattern. As such, the first duplication as generated would be an object in form with the same line segment, curve or pattern. If the pattern includes plural line segments, the first duplication as generated would consequentially include plural line segments. Under such a circumstance, the line segments of the first duplication may be treated a new targeted line segment. On the other hand, objects in the form of curves and patterns cannot be subject to subsequent iterative duplication(s). In accordance with the aforementioned procedures, plural second duplications may then be generated by iterative duplication(s) along each of the line segments (that are linear) of the first duplication. Analogously, a complicated picture that is similar to the pattern may then be generated with continuing iterative duplications. The line segments that may be treated as targeted line segments to be used in the subsequent iterative duplication(s) are referred as iterated lines. The analog rule between the second duplication and an iterated line is represented by the following:

$$\frac{pattern}{baseline} = \frac{first duplication}{targeted segement} = \frac{second duplication}{iterated line}$$

Other than the aforementioned process of using multiple iterative duplications to generate pictures containing large-scaled drawings of similar objects, the attributes of the pictures or duplications as generated may further be configured for advanced processing by the calculating unit 133. The configuration of the attributes includes subjecting the duplications or pictures to transformation, such as mirror reflection and rotation, and hue tuning. The transformation is achieved by geometrical transformation and computation of linear algebra so as to transform the above analog rule of the same ratio to an analog rule that is disproportional or symmetrical, so as to generate the transformed drawings of similar pictures. Because the technical principles underlying the geometrical transformation as adopted by this invention in the field of constructing advanced pictures are commonly adopted by geometrical mathematical calculation and graphics, they are not described in details herein.

In addition, because the line segments of the duplications as generated by the iterative duplication(s) may serve as the targeted line segments (iterated lines) of the subsequent iterative duplication(s), the iterated lines may be further configured by the end-user to determine the number of the iterated lines that are not subject to subsequent iterative duplication(s), and the frequency of the number of the iterated lines that are subject to subsequent iterative duplication(s) or alternative iterative duplications, so as to generate a picture having timing differences thereby enhancing the variations in the final objects and improving the creativity of the end-user.

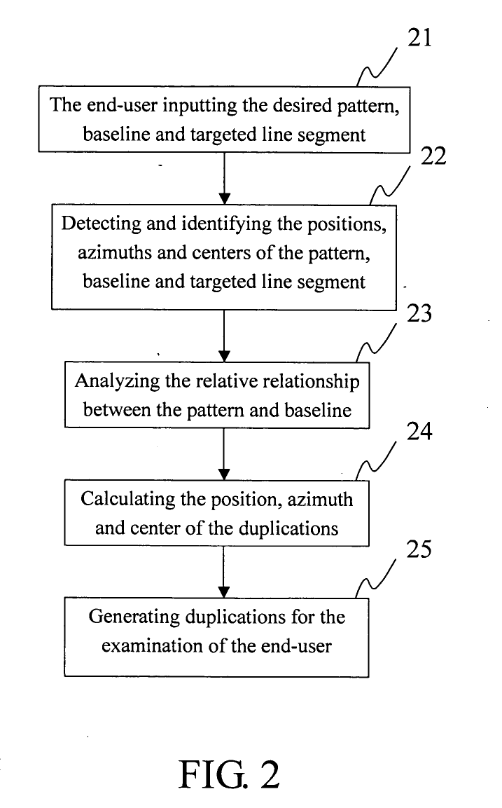

FIG. 2 is a schematic view illustrating the flowchart adopting the method for constructing pictures according to this invention. As described above, in Step 21, the end-user inputs the desired pattern, baseline and targeted line segment that may be drawn by a conventional text processing system, such as selecting modular patterns with minor modifications or dragging a mouse to draw line segments. In Step 22, the system of this invention would detect and identify the positioning information, including the relative positions, azimuths and centers, of the pattern, baseline and targeted line segment. In Step 23, the system would analyze the positioning information between the pattern and baseline to obtain a relative relationship. In Step 24, the system would use the positioning information of the targeted line segments obtained in Step 22 and the relative relationship between the pattern and baseline as obtained in Step 23 to obtain the positioning information of duplications corresponding to each line segment of the targeted line segment. Finally, in Step 25, the duplicated picture as obtained from the positioning information of the duplications is displayed for the examination of the end-user.

Technical Principles

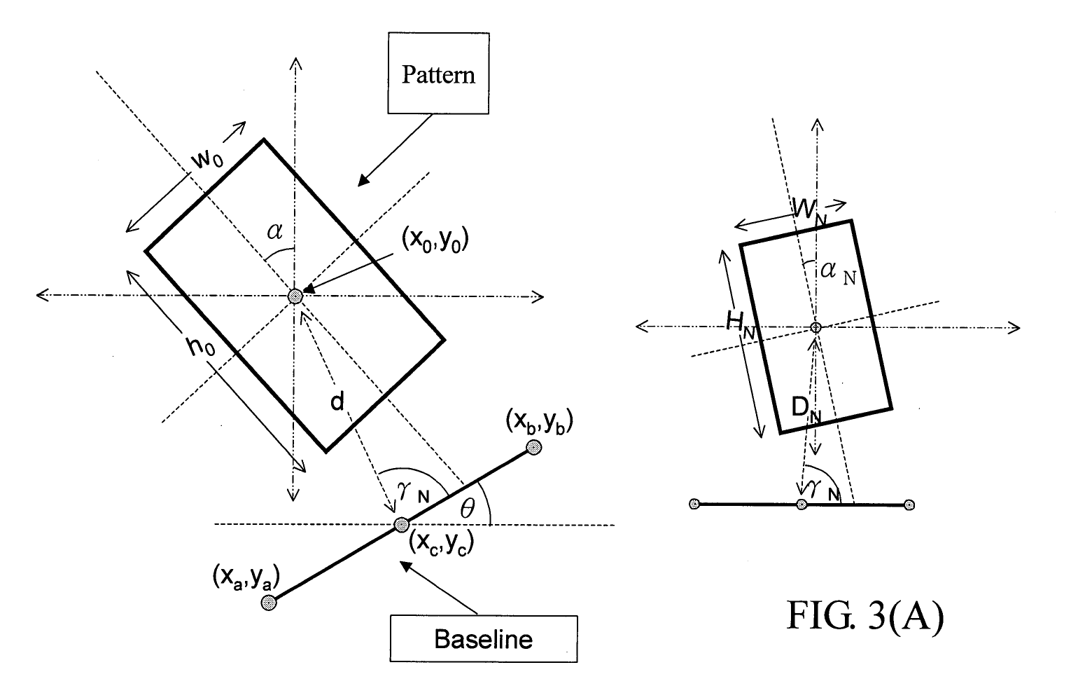

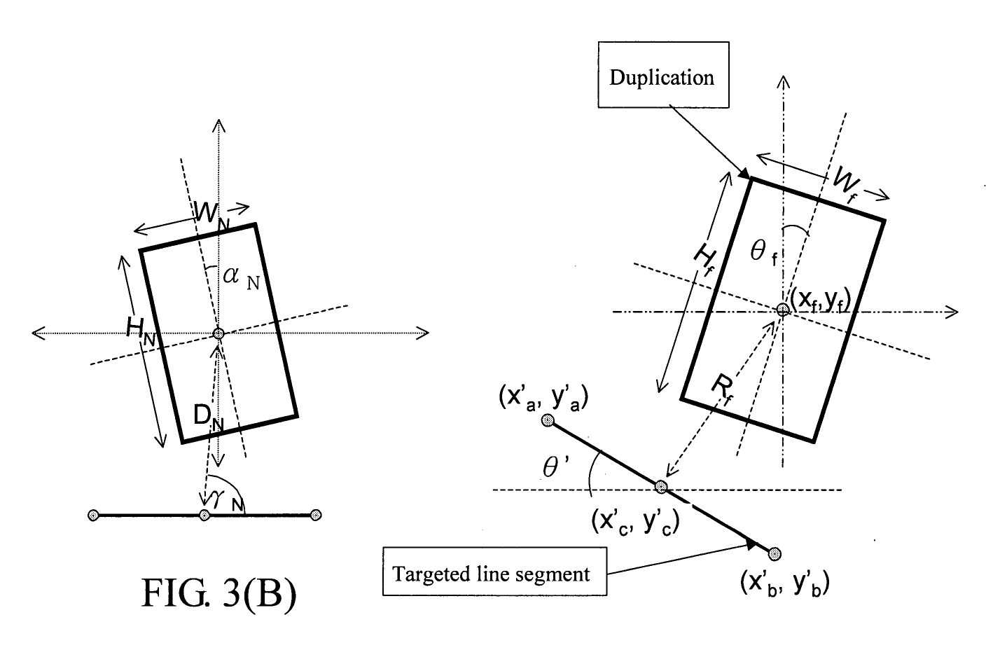

FIGS. 3(A) and 3(B) illustrate the operative principles of the system for constructing pictures according to this invention. According to the aforementioned descriptions, this invention adopts the analog rule of geometry and iterated duplication to generate duplications. It is thus known from the fundamental geometry that the following information is required in order to position an object to a specified position, (1) center of the object, (2) width and length of the object, and (3) azimuth of the object. According to this invention, the relative relationship between the baseline and the pattern serves as the bases for the iterative duplication to anticipate duplication with the same relative relationship along the targeted line segment. With the given information including the relative relationship between the baseline and the pattern, the length and azimuth of the targeted line segment, one is able to calculate the center, length, width and azimuth of the duplication.

In FIG. 3(A), the illustration on the left-hand side includes a pattern and baseline as initially inputted by the end-user. As such, one may obtain the relevant information of the baseline and the pattern.

As shown, the coordinates of the end-points of the baseline are represented by (xₐ,yₐ) and (x_{b},y_{b}), respectively. Accordingly, the coordinates of center of the base line may be represented by (x_{c},y_{c})=((xₐ+x_{b})/2, (yₐ+y_{b})/2) with an azimuth of θ. As such, the length of the line segment of the baseline is represented by r=sort((xₐ−x_{b})\hat{ }2, (yₐ−y_{b})\hat{ }2). At the same time, the coordinates of the center of the pattern may be represented by (x₀,y₀), where the width and height of the pattern are represented by (w₀,h₀), with an azimuth of α. As such, one may obtain the distance between the centers of the baseline, d=sort((x_{c}−x₀)\hat{ }2, (y_{c}−y₀)\hat{ }2) and the included angle γ_{N} between a line connecting the centers of the pattern and baseline, and the baseline.

The relevant information is first normalized by the system of this invention to obtain the distance between the centers of the baseline and pattern, D_{N}=d/r as well as the width and height of the pattern (W_{N},H_{N}), wherein W_{N}=w₀/r and H_{N}=h₀/r . The normalized azimuth of the pattern is α_{N} (based on the azimuth α of the pattern, the distance between the two centers, and the azimuth θ of the baseline). The normalized illustration is illustrated on the right-hand side of FIG. 3(A), where the normalized baseline has a length equals to 1 and an azimuth equals to 0 degree.

Now turning to FIG. 3(B), the illustration on the left-hand side illustrates the relative relationship between the pattern and baseline after normalization. One may then derive the position and dimension of duplication based on information of a targeted line segment provided by the end-user. The coordinates of the end-points of the targeted line segment are represented by (x′ₐ,y′ₐ) and (x′_{b},y′_{b}), respectively. Accordingly, the coordinates of the center of the targeted line segment may be represented by (x′_{c},y′_{c})=((x′ₐ+x′_{b})/2, (y′ₐ+y′_{b})/2) with an azimuth of θ′ and a length of r′=sort((x′ₐ−x′_{b})\hat{ }2, (y′ₐ−y′_{b})\hat{ }2).

The relevant information of the duplication, thus, may be easily computed by means of the information of the targeted line segment as obtained, in accompaniment with the relative relationship between the baseline and the pattern (including the distance between the centers and the included angle between the line connecting the centers and the baseline), to obtain the width of the duplication W_{f}=W_{N}×r′, the height by H_{f}=H_{N}×r′, the distance that the center of the duplication is spaced from the center of the targeted line segment R_{f}=D_{N}×r′, the coordinates of the center of the duplication represented by (x_{f},y_{f}) (based on from the normalized azimuth a N of the pattern, the distance R_{f} between the centers of the duplication and the targeted line segment, and the azimuth θ′ of the targeted line segment), and the azimuth θ_{f} of the duplication (based on the normalized azimuth α_{N} of the pattern, the distance R between the centers of the duplication and targeted line segment, and the azimuth θ′ of the targeted line segment).

Accordingly, by adopting the above computations, the system of this invention is able to obtain the coordinates of the center, width, height and azimuth of the duplication based on the information provided by the pattern, baseline and targeted line segment, so as to place the duplication at a specified position. Similarly, the duplication may be treated to contain plural new targeted line segments, along which new duplications are generated, so as to obtain a complicated picture containing large-scaled drawings of similar objects.

In addition, according to the geometrical transformation mentioned above (not shown), the picture is subject to coordinate transformation by geometrical transformation. In other words, the picture is transformed from X-Y coordinates to U-V coordinates, represented by the following:

$$\{ \begin{matrix}u = p ( x , y ) = \sum \sum {a}_{ij} {x}^{i} {y}^{j} \\ v = q ( x , y ) = \sum \sum {b}_{ij} {x}^{i} {y}^{j}\end{matrix}$$

The following formula may be used to scale, translate or rotate the above picture:

$$( \begin{matrix}u \\ v\end{matrix} ) = λ ( \begin{matrix}cos θ & - sin θ \\ sin θ & cos θ\end{matrix} ) ( \begin{matrix}x \\ y\end{matrix} ) + ( \begin{matrix}{x}_{0} \\ {y}_{0}\end{matrix} )$$

wherein, λ is a scale coefficient. The picture is enlarged when λ>1 and reduced when λ<1. When the scale coefficient along the X and Y-axes are different, the scale coefficient is replaced by the following matrix:

$$( \begin{matrix}u \\ v\end{matrix} ) = [ \begin{matrix}{λ}_{x} & 0 \\ 0 & {λ}_{y}\end{matrix} ] ( \begin{matrix}cos θ & - sin θ \\ sin θ & cos θ\end{matrix} ) ( \begin{matrix}x \\ y\end{matrix} ) + ( \begin{matrix}{x}_{0} \\ {y}_{0}\end{matrix} )$$

Hence, the end-user would only need to configure the required transformation to subject the duplication or pictures obtained through iterative duplication to the transformation, thereby obtaining transformed pictures containing large-scaled drawings of similar objects after the above computations.

Actual Results

This invention may be adopted in various ways to obtain different results. A few simple embodiments are used to facilitate the explanations. However it should be noted that the scope of this invention should not be limited by the examples as provided.

### First Embodiment

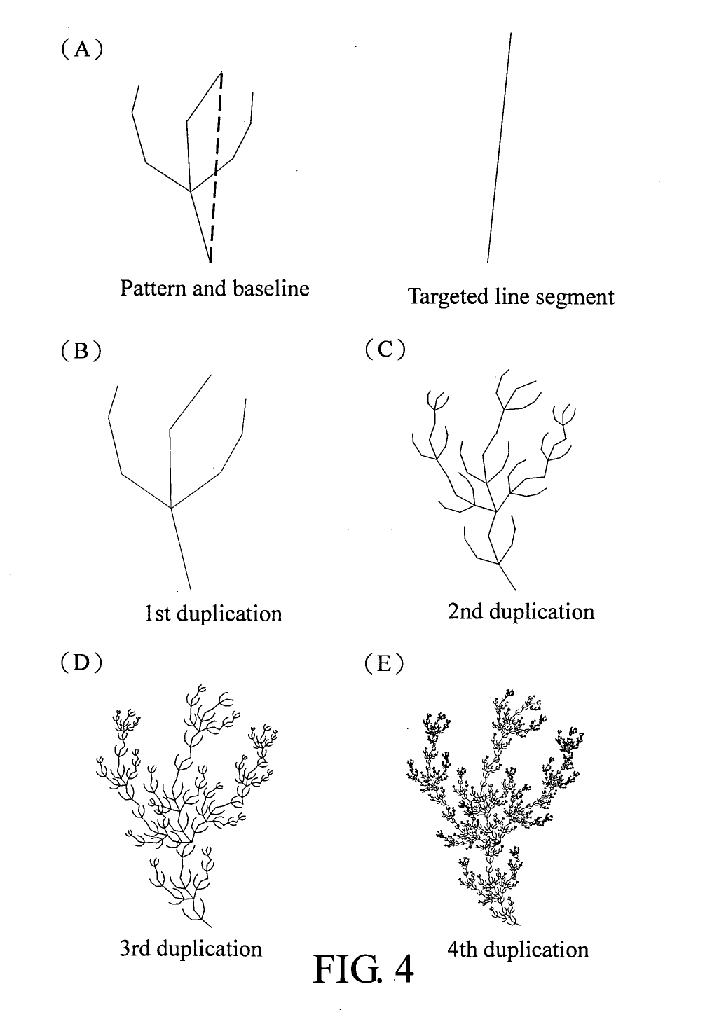

FIG. 4 illustrates a resulting picture generated by a first embodiment of the system for constructing pictures, after being subject to multiple iterative duplications based on a pattern, baseline and a targeted line segment. FIG. 4(A) illustrates the pattern, pattern (dashed line) and targeted line segment. FIG. 4(B) illustrates a first duplication that is a picture generated along the targeted line segment having a relative relationship in conformity with the relative relationship between the pattern and baseline after being subject to the first iterative duplication. FIG. 4(C) illustrates a second duplication that is generated along the first duplication. Because the pattern includes plural line segments, the first duplication likewise includes the same number of plural line segments. The second duplication uses the plural line segments of the first duplication as the targeted line segments, along which pictures each having a relative relationship in conformity with the relative relationship between the pattern and baseline are generated. FIGS. 4(D) and 4(E) are resulting pictures after being subject to the third and fourth iterative duplications.

### Second Embodiment

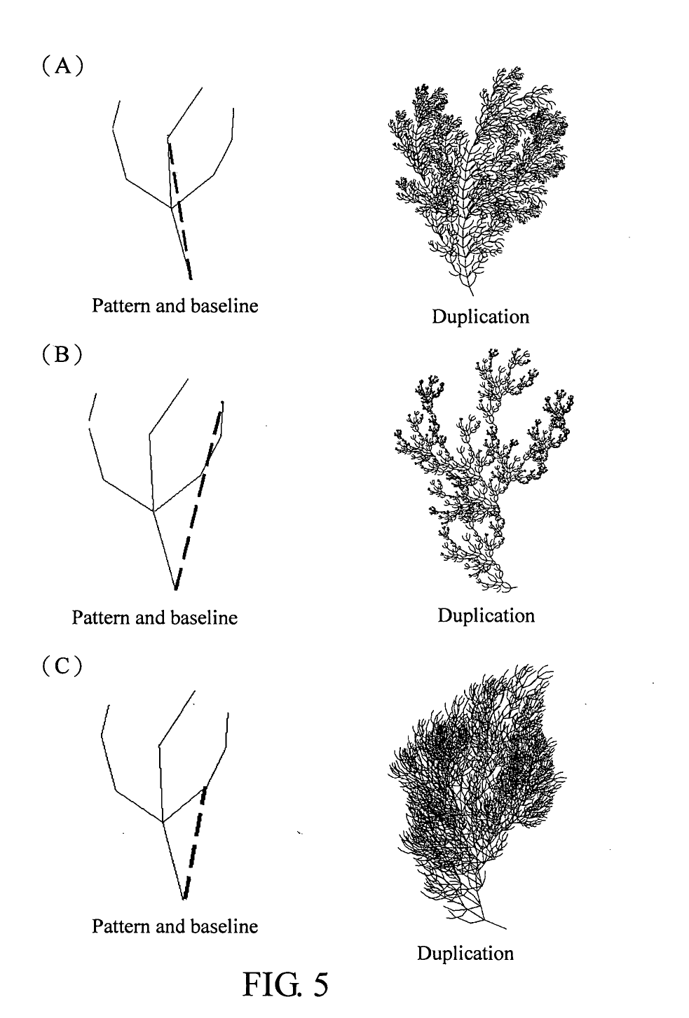

FIG. 5 illustrates resulting pictures generated by a second embodiment of the system for constructing pictures, using a pattern and a line segment identical to those in FIG. 4 and baselines (dashed lines) of different azimuths, after being subject to multiple iterative duplications. One may easily observe from FIG. 5 that, minor modifications in the baselines would result in completely different pictures of duplications. Hence, in actual applications, minor adjustments in the baseline by the end-user would result in a variety of complicated pictures, without detailed drawing procedures.

### Third Embodiment

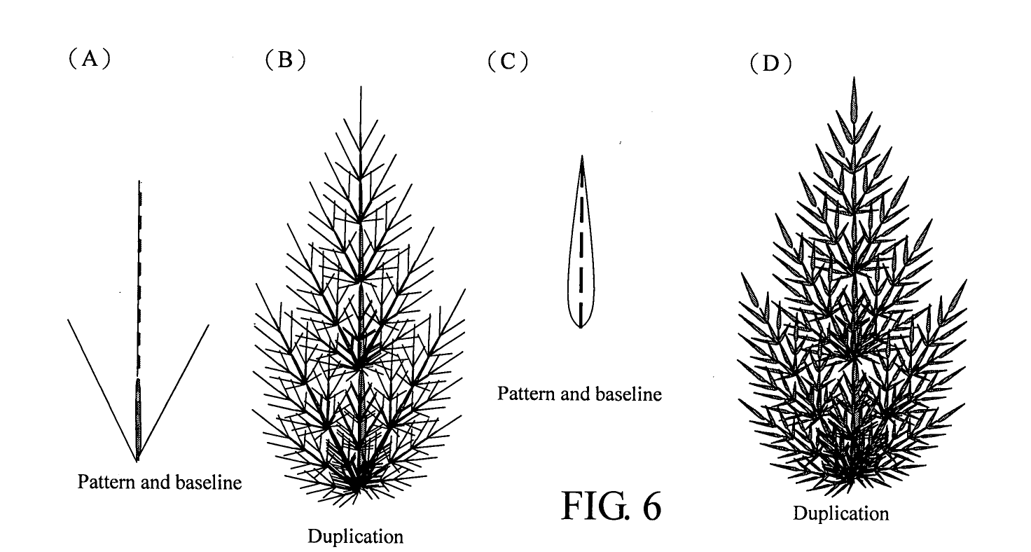

FIG. 6 illustrates the resulting pictures generated by a third embodiment of the system for constructing pictures, where different patterns are used for the iterative duplications. In this embodiment, duplication as shown in FIG. 6(B) is obtained after being subject to multiple iterative duplications of the pattern and baseline (dashed line) illustrated in FIG. 6(A) and a targeted line segment in the form of a line segment (not shown). Iterative duplication is then applied to the leaf shown in FIG. 6(C) that is used as a pattern and the duplication in FIG. 6(B) that is treated as a targeted line segment, to obtain a picture similar to a coniferous tree found in the great nature, where the leaf configuration is generated at each of the tips. Hence, the end-user is may freely change the patterns applied in the subsequent iterative duplication(s) to easily generate a complicated picture similar to an object found in the great nature.

### Fourth Embodiment

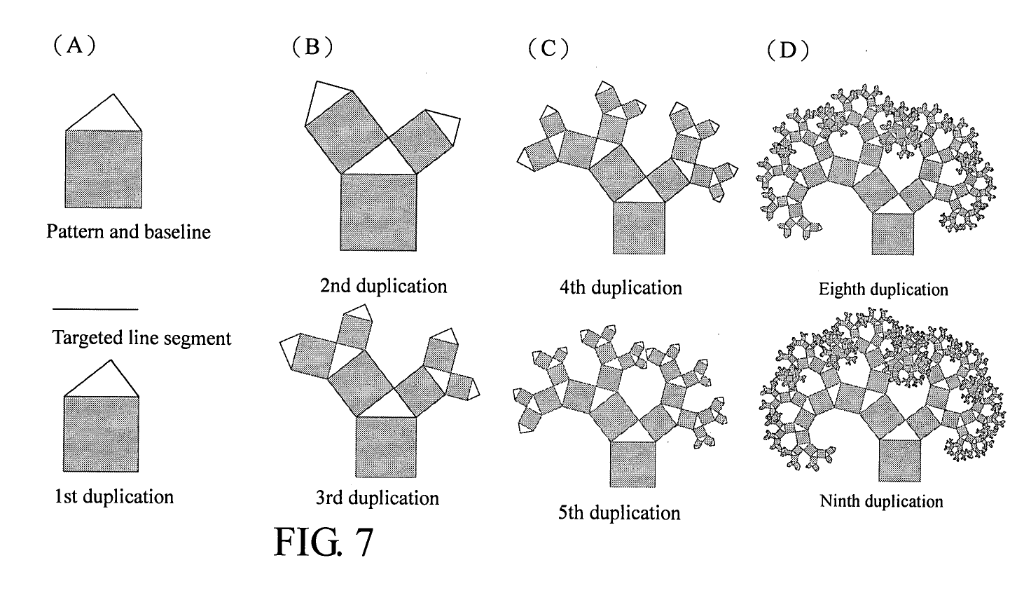

FIG. 7 illustrates a resulting picture of a Pythagorean tree generated by a fourth embodiment of the system for constructing pictures according to this invention, using a square object and two perpendicular line segments as the pattern. A complicated Pythagorean tree as shown in FIG. 7(D) (after nine iterative duplications) may be obtained by adopting the iterative duplication of this invention without the need of writing programs or complicated operations.

### Fifth Embodiment

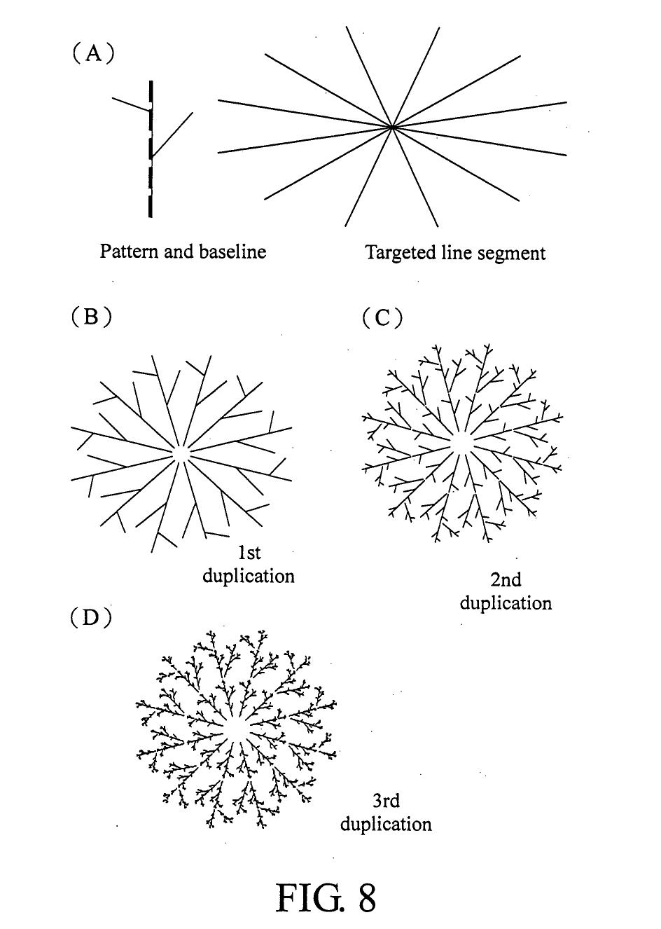

FIG. 8 illustrates the resulting pictures generated by a fifth embodiment of the system for constructing pictures. The prior embodiments all use a targeted line segment with a single line segment. This embodiment, however, illustrates the resulting pictures of a targeted line segment containing line segments with different azimuths after being subject to multiple iterative duplications (upon three iterative duplications).

### Sixth Embodiment

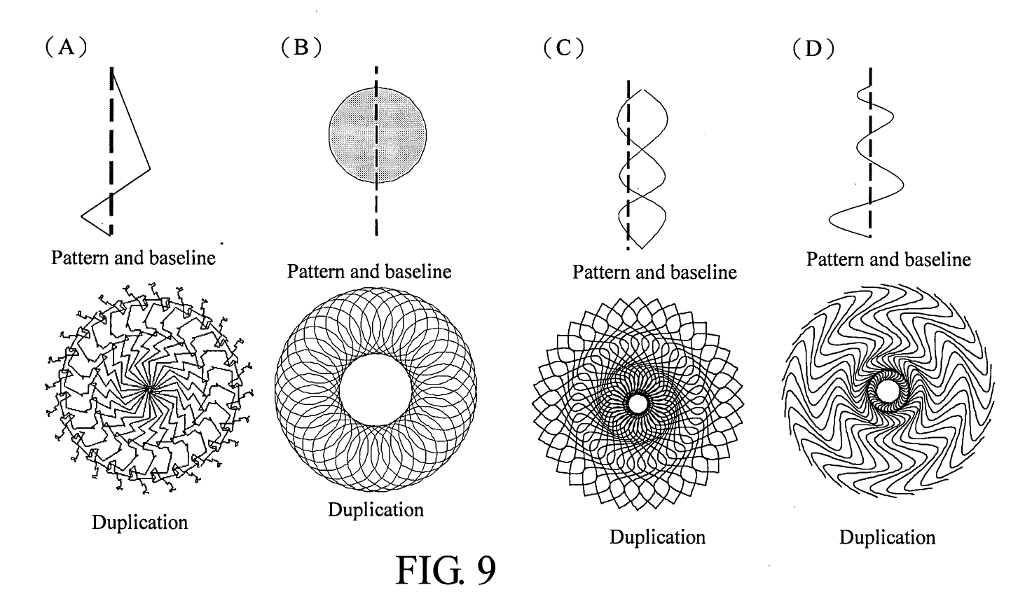

FIG. 9 illustrates the different pictures generated by a sixth embodiment of the system for constructing pictures, after being subject to iterative duplications based on a baseline and a targeted line segment identical to those in FIG. 8 and different patterns.

### Seventh Embodiment

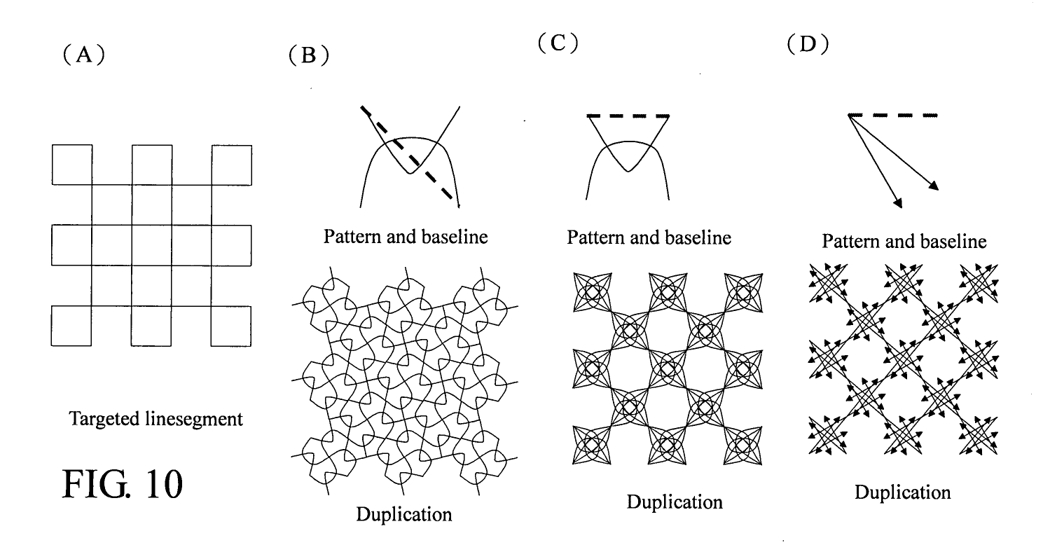

FIG. 10 illustrates the different pictures generated by a seventh embodiment of the system for constructing pictures, after being subject to multiple iterative duplications based on a targeted line segment containing plural line segments with different azimuths as shown in FIG. 10(A), and different patterns and baselines of different azimuths (dashed lines).

### Eighth Embodiment

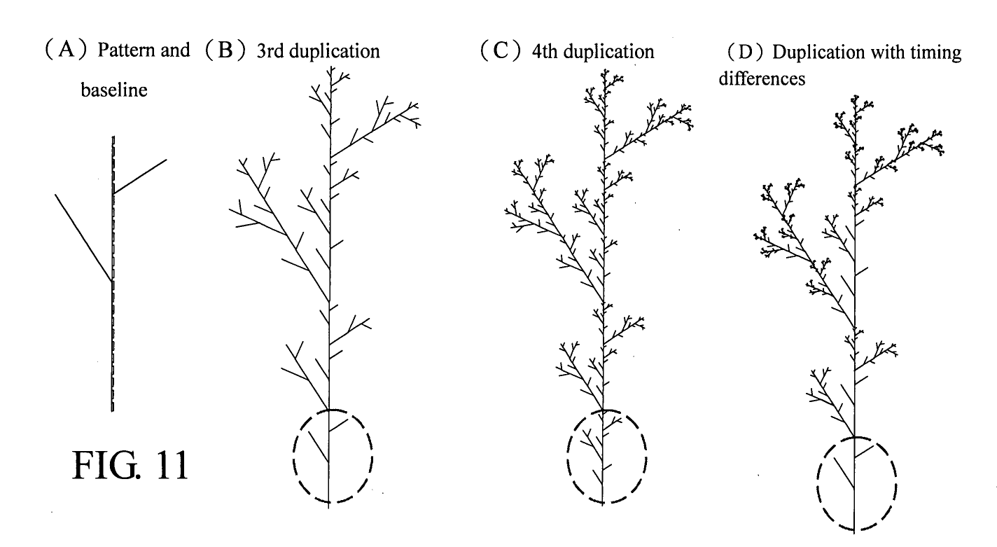

FIG. 11 illustrates the comparative resulting pictures generated by an eighth embodiment of the system for constructing pictures, where duplications with and without timing differences are used during the iterative duplications. FIG. 11(A) illustrates the pattern and baseline (dashed line). FIG. 11(B) illustrates duplication after being subject to three iterative duplications. FIG. 11(B) illustrates duplication after being subject to four iterative duplications. In accordance with the prior description, the line segments of the duplication in FIG. 11(B) may be further configured by the end-user to determine whether the line segments of the duplication in FIG. 11(B) are subject to subsequent iterative duplication(s), or that the line segments within the scope of the dashed circle are not subject to subsequent iterative duplication(s). Hence, iterative duplication is only applied to the portion outside the dashed circle while the relative positions of the line segments within the dashed circle in FIG. 11(D) remain unchanged. As compared to FIG. 11(D), the line segments within the dashed circle in FIG. 11(C) are subject to iterative duplications.

Hence, according to the technical principles and examples of carrying out this invention as described above, the end-user is able to draw pictures containing large-scaled drawings of similar objects in a simple manner. As such, the end-user is able to create and design various fractals or other complicated pictures containing large-scaled drawings of similar objects, with the provision of the information for visualizing the line segments, and to configure the attributes of the pictures and duplications or the iterative duplication with timing differences, without the need of recording, writing abstruse programs, describing pictures by formal language, or drawings lines, thereby enhancing the efficiency for drawing complicated pictures, and making breakthroughs by eliminating the applications of programming.

Accordingly, this invention provides a system and method for constructing large-scaled drawings of similar objects based on the analog rule and iterative duplication, the composition of the baselines and patterns, or the attributes and timing differences of the line segments may be manually manipulated and modified to easily and quickly generate complicated pictures with different variations. In addition, the technical principles and computations involved in this invention may be easily achieved without the need of using specialized platforms or hardware, such that this invention may be adopted in the fields of artistic designs, drafting and instructions due to the simple operations as involved.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. A method for constructing pictures, for generating large-scaled drawings of similar objects, comprising the steps of:
(a) inputting a pattern, a baseline, and a line segment at a first, a second and a third positions, respectively, by an end-user, the pattern, baseline and line segment having a first, a second and a third dimensions and a first, a second and a third azimuths, respectively;
(b) analyzing a relative relationship existing between the pattern and the baseline in accordance with the positions, dimensions and azimuths of the pattern and baseline;
(c) generating a first duplication at a fourth position through iterative duplication, by scaling the pattern with a first ratio and then translating the pattern in accordance with the second position, dimension and azimuth of the line segment using the relative relationship between the pattern and the baseline as a reference, such that the first duplication and the targeted line segment conform with the relative relationship between the pattern and the baseline; and
(d) displaying the first duplication at the fourth position as a first picture for examination of the end-user.

2. The method of claim 1, wherein the pattern includes at least a first line segment, rendering the first duplication to include at least a second line segment due to conformity with the relative relationship.

3. The method of claim 2, further comprising the steps of:
(e) identifying a fifth position at where the second line segment is located, and detecting a fifth dimension and azimuth of the second line segment;
(f) treating the second line segment as a new targeted line segment, and generating a second duplication of the pattern at a sixth position by scaling the pattern with a second ratio and translating the pattern in accordance with the fifth position, dimension, azimuth of the second line segment using the relative relationship between the pattern and the baseline as a reference, such that the second duplication and the second line segment conform with the relative relationship between the pattern and the baseline; and
(g) displaying the second duplication at the sixth position as a second picture for examination of the end-user.

4. The method of claim 3, wherein the second line segment is an iterated line serving as a targeted line segment to be used in the subsequent iterative duplication.

5. The method of claim 4, further comprising the steps of:
(h) treating the plural line segments generated by repeating steps (e) and (f) as plural iterated lines and generating different pictures using the plural iterated lines.

6. A system for constructing pictures, for generating large-scaled drawings of similar objects, comprising:
a storage module;
an interface device serving as an input device to be used by an end-user to input a pattern, a baseline and a targeted line segment;
a detecting unit, for detecting and identifying positioning information, including relative positions, dimensions, azimuths and centers of the pattern, baseline and targeted line segment upon inputting the pattern, baseline and targeted line segment, and storing the positioning information in the storage module;
an analyzing unit, for obtaining a relative relationship existing between the pattern and the baseline to be stored in the storage module upon accessing the positioning information stored in the storage module; and
a calculating unit, for calculating positioning information of a first duplication based on the positioning information of the targeted line segment upon accessing the relative relationship stored in the storage module and the positioning information of the targeted line segment, thereby subjecting a relative relationship between the first duplication and the targeted line segment to conform with the relative relationship between the pattern and the baseline, and for displaying the first duplication on the interface device.

7. The system of claim 6, wherein the pattern includes at least a first line segment, rendering the first duplication to include at least a second line segment due to conformity with the relative relationship.

8. The system of claim 7, wherein the calculating unit treats the second line segment as a new targeted line segment, to generate a second duplication upon accessing the relative position, dimension, azimuth and center of the second line segment.

9. The system of claim 8, wherein the calculating unit allows configuration of attributes of the line segment of the second duplication or the object in response to configuration made by the end-user to facilitate advanced processing of the second duplication.

10. A method for constructing pictures, for generating large-scaled drawings of similar objects, comprising the steps of:
providing a pattern, a baseline and a targeted line segment;
analyzing a relative relationship between the pattern and the baseline; and
generating a first duplication along the targeted line segment having a relative relationship identical to the relative relationship and displaying the first duplication as a first picture.

11. The method of claim 10, further comprising the steps of:
treating each line segment of the first duplication as a new targeted line segment; and
generating a second duplication along each of the line segments of the first duplication having a relative relationship identical to the relative relationship and displaying the second duplications as a second picture.

12. The method of claim 11, further comprising the step of: configuring attributes of the second duplication by subjecting the second duplication to transformation, such as mirror reflection and rotation and hue tuning, to generate transformed drawings of similar pictures.

13. The method of claim 11, wherein the plural targeted line segments in the first duplication are treated as plural iterated lines, and the number of the iterated lines that are not subject to subsequent iterative duplication, and the frequency of the number of the iterated lines that are subject to subsequent iterative duplication or alternative iterative duplication may be configured to generate a picture having timing differences.

14. The method of claim 12, wherein each targeted line segment may be transformed into a new picture by the transformtion randomly or functionally.

15. A system for constructing pictures, for generating large-scaled drawings of similar objects, comprising:
an interface device and a system control module, the interface device serving as an input device to be used by an end-user to input a pattern, a baseline and a targeted line segment to generate a duplication, characterized in that: the system control module generates a first duplication analogous to the pattern upon identifying positioning information of and analyzing a relative relationship between the pattern and the baseline, the first duplication being displayed on the interface device, such that a relative relationship between the first duplication and the targeted line segment conforms with the relative relationship between the pattern and the baseline.

16. The system of claim 15, wherein the system control module treats the first duplication as a new targeted line segment to generate a second duplication analogous to the pattern and displayed on the interface device, such that a relative relationship between the second and first duplications conforms with the relative relationship between the pattern and the baseline.

17. The system of claim 16, wherein the line segment in the pattern is subject to configuration of attributes, such as mirror reflection and rotation, and hue tuning to generate transformed drawings of similar pictures for the second duplication.
